(19) United States
(12) Patent Application Publication
(10) Pub. No.: US 2014/0082026 A1
(43) Pub. Date: Mar. 20, 2014

(54) SYSTEM, METHOD AND COMPUTER PROGRAM PRODUCT FOR DEFINING A RELATIONSHIP BETWEEN OBJECTS

(71) Applicant: salesforce.com, inc, San Francisco, CA (US)

(72) Inventor: Robert Lancaster, Melbourne (AU)

(21) Appl. No.: 13/913,346

(22) Filed: Jun. 7, 2013

Related U.S. Application Data
(60) Provisional application No. 61/701,271, filed on Sep. 14, 2012.

(51) Int. Cl. G06F 17/30

(52) U.S. Cl. CPC G06F 17/30289
USPC 707/803

(57) ABSTRACT

In accordance with embodiments, there are provided mechanisms and methods for defining a relationship between objects. These mechanisms and methods for defining a relationship between objects can enable increased efficiency and revenue, optimized data analysis, etc.

### CLAIM OF PRIORITY

This application claims the benefit of U.S. Provisional Patent Application No. 61/701,271, entitled “SYSTEM AND METHOD FOR TRACKING RELATIONSHIPS BETWEEN DATA OBJECTS IN AN ON-DEMAND SYSTEM,” by Robert Lancaster, filed Sep. 14, 2012 (Attorney Docket No. 1006PROV), the entire contents of which are incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

One or more implementations relate generally to data objects, and more particularly to defining relationships between data objects.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also be inventions.

Customer relationship management (CRM) is a useful model for managing interactions associated with customers, associates, and other objects of a system. Unfortunately, techniques for establishing and tracking relationships within a CRM model have been associated with various limitations.

Just by way of example, there are currently no means by which a CRM system can establish and track relationships between entities within the CRM system. Accordingly, it is desirable to provide techniques that allow for the definition of relationships of objects within a system.

### BRIEF SUMMARY

In accordance with embodiments, there are provided mechanisms and methods for defining a relationship between objects. These mechanisms and methods for defining a relationship between objects can enable increased efficiency and revenue, optimized data analysis, etc.

In an embodiment and by way of example, a method for defining a relationship between objects is provided. In one embodiment, a first object and a second object are identified within a system. Additionally, a relationship is defined between the first object and the second object. Further, the defined relationship is stored within the system. A one to many relationship may exist between the first object and the relationship object, and a one to many relationship may exist between the second object and the relationship object Because of this structure, many relationships can exist between the first and second object.

While one or more implementations and techniques are described with reference to an embodiment in which defining a relationship between objects is implemented in a system having an application server providing a front end for an on-demand database system capable of supporting multiple tenants, the one or more implementations and techniques are not limited to multi-tenant databases nor deployment on application servers. Embodiments may be practiced using other database architectures, i.e., ORACLE®, DB2® by IBM and the like without departing from the scope of the embodiments claimed.

Any of the above embodiments may be used alone or together with one another in any combination. The one or more implementations encompassed within this specification may also include embodiments that are only partially mentioned or alluded to or are not mentioned or alluded to at all in this brief summary or in the abstract. Although various embodiments may have been motivated by various deficiencies with the prior art, which may be discussed or alluded to in one or more places in the specification, the embodiments do not necessarily address any of these deficiencies. In other words, different embodiments may address different deficiencies that may be discussed in the specification. Some embodiments may only partially address some deficiencies or just one deficiency that may be discussed in the specification, and some embodiments may not address any of these deficiencies.

### BRIEF DESCRIPTION OF THE DRAWINGS

In the following drawings like reference numbers are used to refer to like elements. Although the following figures depict various examples, the one or more implementations are not limited to the examples depicted in the figures.

FIG. 1 illustrates a method for defining a relationship between objects, in accordance with one embodiment;

FIG. 2 illustrates a method for creating a relationship between two objects, in accordance with another embodiment;

FIG. 3 illustrates an exemplary contact detail page, in accordance with another embodiment;

FIG. 4 illustrates another exemplary contact detail page, in accordance with another embodiment;

FIG. 5 illustrates an exemplary reward indication page, in accordance with another embodiment;

FIG. 6 illustrates an exemplary user information page, in accordance with another embodiment;

FIG. 7 illustrates a method for interacting with an existing relationship within a system, in accordance with another embodiment;

FIG. 8 illustrates an exemplary contact relationship page, in accordance with another embodiment;

FIG. 9 illustrates an exemplary introduction request form, in accordance with another embodiment;

FIG. 10 illustrates an account detail page, in accordance with another embodiment;

FIG. 11 illustrates a block diagram of an example of an environment wherein an on-demand database system might be used; and

FIG. 12 illustrates a block diagram of an embodiment of elements of FIG. 11 and various possible interconnections between these elements.

### DETAILED DESCRIPTION

### General Overview

Systems and methods are provided for defining a relationship between objects.

As used herein, the term multi-tenant database system refers to those systems in which various elements of hardware and software of the database system may be shared by one or more customers. For example, a given application server may simultaneously process requests for a great number of customers, and a given database table may store rows for a potentially much greater number of customers.

Next, mechanisms and methods for defining a relationship between objects will be described with reference to example embodiments.

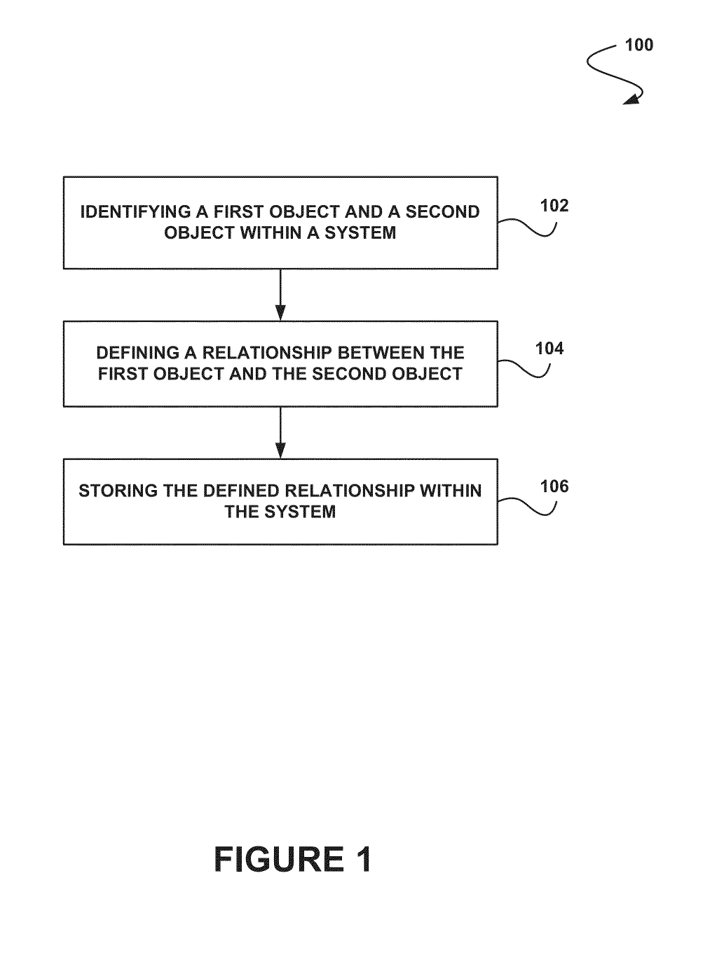

FIG. 1 illustrates a method 100 for defining a relationship between objects, in accordance with one embodiment. As shown in operation 102, a first object and a second object are identified within a system. In one embodiment, the system may include a multi-tenant on-demand database system. In another embodiment, the system may include a customer relationship management (CRM) system. For example, the system may include a system for managing one or more of customers, vendors, contacts, accounts, etc.

Additionally, in one embodiment, the first and second objects may include data stored within the system. For example, each of the first and second objects may include data representative of an object (e.g., a table, etc.) that is stored in one or more databases of the system. In another embodiment, one or more of the first and second objects may include an object representative of a user of the system (e.g., a customer, an employee, etc.). In yet another embodiment, one or more of the first and second objects may include a contact within the system (e.g., a business contact, etc.). In still another embodiment, one or more of the first and second objects may include an account within the system e.g., a corporation, a provider of services and/or goods, etc.).

Further, in one embodiment, the first object and the second object may be identified within an account of the system. For example, the first object and the second object may be stored in association with an account established within the system. In another embodiment, the first object and the second object may be identified in response to one or more user actions utilizing a graphical user interface (GUI). For example, a user may log into the system, utilizing the GUI, and may be identified as the first object in response to the logging in. In another example, the user may select the second object utilizing a page of the GUI that is presented to the user after the user has signed in. In yet another example, a third party may identify both the first object and the second object, utilizing a provided GUI.

Further still, in one embodiment, the first object and the second object may be identified from an external system separate from the system. For example, the first object and the second object may be imported from the external system into the system.

Also, it should be noted that, as described above, such multi-tenant on-demand database system may include any service that relies on a database system that is accessible over a network, in which various elements of hardware and software of the database system may be shared by one or more customers (e.g. tenants). For instance, a given application server may simultaneously process requests for a great number of customers, and a given database table may store rows for a potentially much greater number of customers. Various examples of such a multi-tenant on-demand database system will be set forth in the context of different embodiments that will be described during reference to subsequent figures.

Additionally, as shown in operation 104, a relationship is defined between the first object and the second object. In one embodiment, the relationship may be defined utilizing a GUI. For example, a user may define the relationship between the first object and the second object utilizing a GUI page or pages provided to the user after the user has signed in and selected the first object and the second object. In another example, a third party may define the relationship in addition to identifying both the first object and the second object, utilizing a provided GUI. In another embodiment, the relationship may be imported from an external system separate from the system. For example, the first object and the second object, as well as the relationship between the first and second objects, may be imported from the external system into the system.

Further, in one embodiment, the relationship may include one or more parameters. For example, the parameters may include a type of the relationship, the strength of the relationship, a textual description of the relationship, etc. In another embodiment, the relationship may include one or more of an ability and willingness of one or more entities associated with the relationship to make an introduction. For example, the first object may include a user, the second object may include a contact, and the relationship between the first and second object may include a willingness of the user to initiate an introduction between the contact and a third party.

Further still, in one embodiment, defining the relationship may include receiving the one or more parameters as input and associating the one or more parameters with the first and second objects. In another embodiment, defining the relationship may include retrieving the one or more parameters from an external system and associating the one or more parameters with the first and second objects.

Also, as shown in operation 106, the defined relationship is stored within the system. In one embodiment, the relationship may be stored as an object (e.g., a relationship object, etc.) within the system. For example, data representative of the relationship may be stored as an object in one or more databases of the system. In another embodiment, the defined relationship may be associated with one or more of the first object and the second object. For example, one or more flags, links, identifiers, etc. may be stored in association with both the defined relationship and the one or more of the first object and the second object. In another example, an identifier of both the first object and the second object may be stored within the defined relationship, and an identifier of the defined relationship may be stored within one or more of the first object and the second object.

In addition, in one embodiment, one or more actions may be performed in response to the defining and storing of the relationship. For example, if the relationship between the first object and the second object is defined by a user, the user may be assigned one or more credits (e.g., points, etc.). For instance, a points total associated with the user may be increased by a numeric amount when the user defines the relationship. In another embodiment, the amount of credits assigned to the user may vary based on one or more parameters of the relationship (e.g., the strength of the relationship, the willingness to make an introduction, etc.).

Furthermore, in one embodiment, one or more messages may be posted in response to the defining and storing of the relationship. For example, one or more messages may be posted to a web page associated with the first and/or second object in response to the defining and storing of the relationship. In another example, one or more messages may be posted to a web page associated with a parent of the first and/or second object in response to the defining and storing of the relationship. These messages or alerts can be sent to interested parties via various means, such as an internal social network, email, SMS, via a web page, etc.

Further still, in one embodiment, the stored relationship may be identified in association with the first object or the second object. In another embodiment, the stored relationship may be displayed when viewing details of the first object or the second object. For example, the stored relationship may be displayed in response to a user request to view one or more relationships associated with the first object or the second object. In yet another embodiment, one or more parameters included within the stored relationship may be displayed when the stored relationship is displayed.

Also, in one embodiment, an option to request an introduction may be conditionally provided in association with the display of the stored relationship. For example, when details of an object (e.g., the first object or the second object) are displayed to a user, the stored relationship may be displayed to the user in addition to an option to request an introduction associated with the object. For example, if the object includes a contact with a relationship to another user, an option to request an introduction with the contact by the other user may be provided.

Additionally, in one embodiment, the option to request an introduction associated with the object may be conditionally displayed. For example, if the object includes a contact with a relationship to another user, an option to request an introduction with the contact by the other user may be conditionally provided based on an ability and/or willingness to provide the introduction that is input by the other user. In another embodiment, one or more actions may be performed if the option to request an introduction is selected. For example, one or more messages may be sent and/or posted to a web page associated with one or more of the first object and the second object.

Further, in one embodiment, all relationships associated with an object may be displayed when viewing details for that object. For example, all relationships associated with an object, including one or more parameters associated with each relationship, may be displayed in response to a user request to view details for the object.

Further still, in one embodiment, an analysis may be performed, utilizing the stored relationship. In another embodiment, a plurality of stored relationships may be analyzed, and one or more actions may be performed, based on the analysis. For example, one or more statistics associated with relationships associated with a parent object may be identified by aggregating and analyzing relationships of child objects of the parent. In another example, a number of relationships associated with a parent object may be determined, the relationships associated with a parent object may be classified according to one or more parameters, etc.

Also, in one embodiment, performing one or more actions may include presenting the statistics to one or more users. For example, the statistics may be presented to the users, utilizing one or more reports. In another embodiment, a plurality of stored relationships may be analyzed by one or more applications of the system. For example, the plurality of stored relationships may be analyzed to determine parent objects that are the most connected to an entity, relationship types that are associated with the entity and that are the most prevalent within the entity, etc.

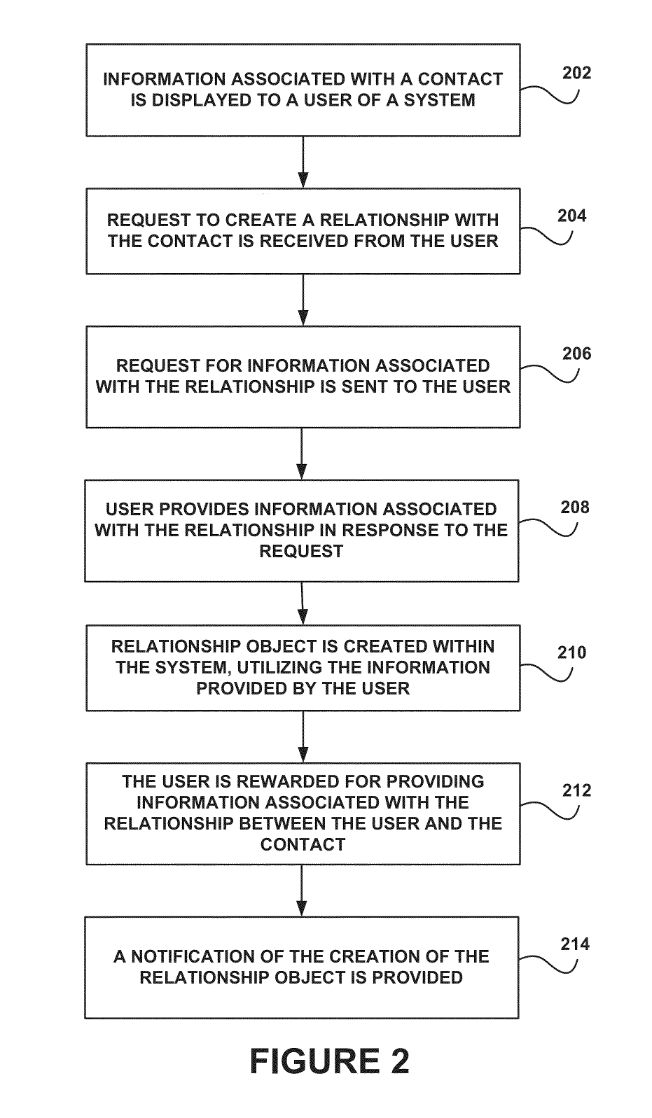

FIG. 2 illustrates a method 200 for creating a relationship between two objects, in accordance with another embodiment. As an option, the present method 200 may be carried out in the context of the functionality of FIG. 1. Of course, however, the method 200 may be carried out in any desired environment. The aforementioned definitions may apply during the present description.

As shown in operation 202, information associated with a contact is displayed to a user of a system. In one embodiment, the information associated with the contact may include information stored within an object that represents the contact within the system. For example, the information associated with the contact may include information stored within a table of the system, where such table is identified as the contact object. In another embodiment, the contact may be associated with an account (e.g., an employer of the contact, etc.).

In still another embodiment, the contact may be associated with an opportunity within the system (e.g., a potential business opportunity with the user, etc.). In another embodiment, the user may be represented by an object within the system. For example, information associated with the user may be stored within an object that represents the user within the system. In yet another embodiment, the system may include a customer relationship management (CRM) system.

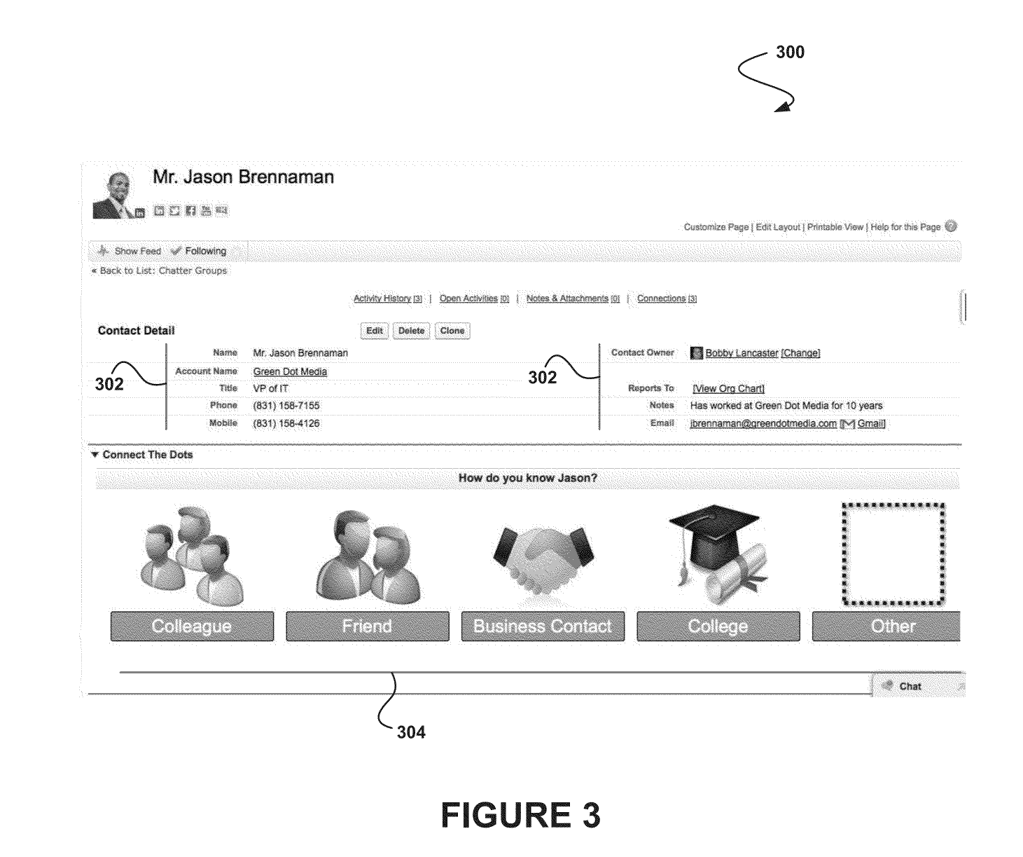

Additionally, in one embodiment, the information associated with the contact may be displayed to the user utilizing a graphical user interface (GUI). For example, the information associated with the contact may be displayed within a contact page summarizing the contact. FIG. 3 illustrates an exemplary contact detail page 300, in accordance with one embodiment. As shown, the contact detail page 300 includes contact detail information 302.

Further, as shown in operation 204, a request to create a relationship with the contact is received from the user. In one embodiment, the request may be received in response to the user selecting a link within a GUI. For example, the user may select a link to add a relationship with the contact (e.g., a link indicating that the user knows the contact, etc.) from within the contact page.

Further still, as shown in operation 206, a request for information associated with the relationship between the user and the contact is sent to the user. In one embodiment, sending the request for information may include providing one or more GUI pages to the user with one or more options for the user to select. For example, the one or more GUI pages may include a request to provide one or more parameters associated with the relationship between the user and the contact. These parameters may include a type of the relationship, the strength of the relationship, a personal description of the relationship, an ability and/or willingness of the user to introduce the contact to third parties, etc.

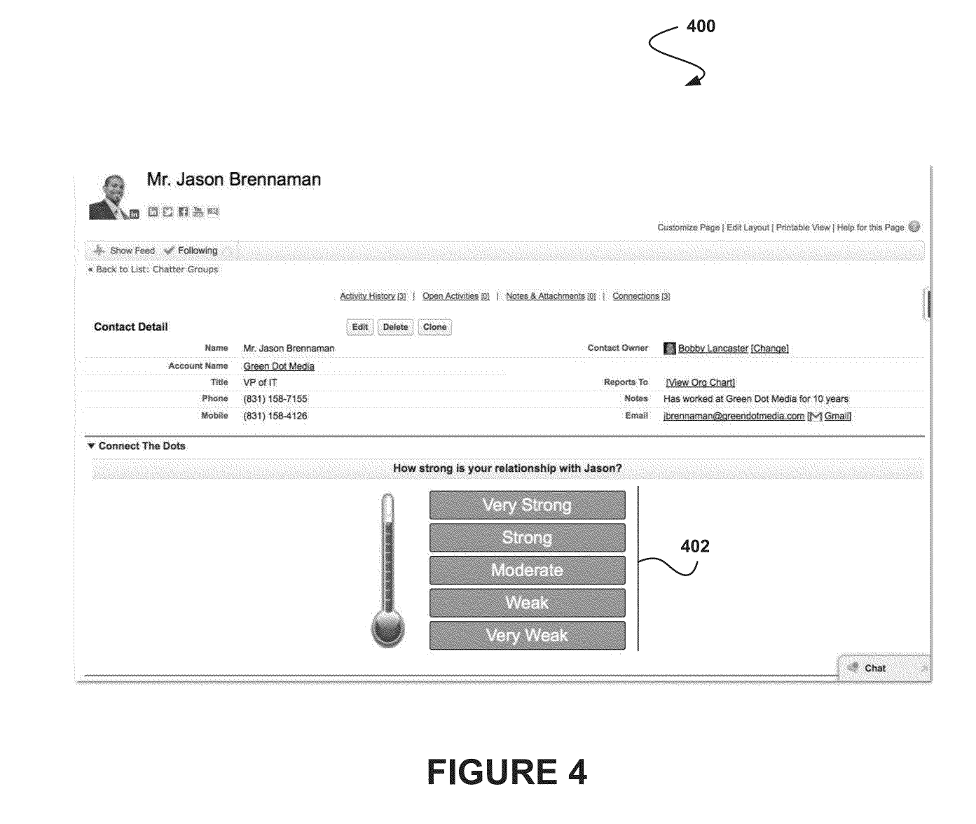

For instance, the contact detail page 300 in FIG. 3 includes a connection interface 304 that includes a plurality of options that may be selected by the user that allow the user to indicate how the user knows the contact. Additionally, FIG. 4 illustrates another exemplary contact detail page 400, in accordance with one embodiment, where the contact detail page 400 includes a connection interface 404 that includes a plurality of options that may be selected by the user that allow the user to indicate the strength of the relationship between the user and the contact.

Also, as shown in operation 208, the user provides information associated with the relationship between the user and the contact in response to the request. In one embodiment, the user may provide the information associated with the relationship by inputting the information utilizing the one or more GUI pages provided to the user. In another embodiment, the provided information may include one or more parameters associated with the relationship between the user and the contact.

In addition, as shown in operation 210, a relationship object is created within the system, utilizing the information provided by the user. In one embodiment, the relationship object may include a table within the system that stores one or more parameters associated with the relationship between the user and the contact. In another embodiment, the relationship object may be linked to the object associated with the user, as well as the object associated with the contact.

Further, as shown in operation 212, the user is rewarded for providing information associated with the relationship between the user and the contact. For example, the user may be assigned one or more credits (e.g., points, etc.) in response for providing the relationship information. In another embodiment, the number of credits assigned to the user may be dependent on the strength of the relationship indicated by the user, the willingness of the user to introduce the contact, or any other factor.

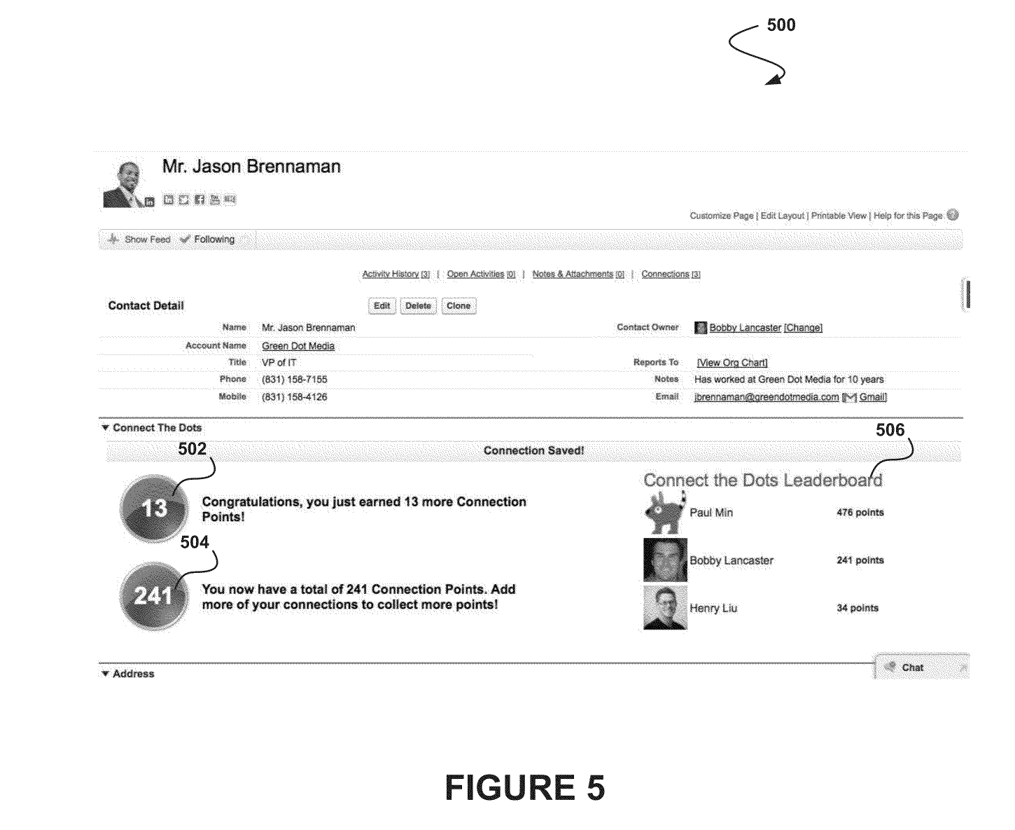

FIG. 5 illustrates an exemplary reward indication page 500, in accordance with one embodiment. As shown, the reward indication page 500 includes an indication of a number of connection points 502 that are rewarded to the user for submitting the relationship information, as well as a total number of connection points 504 earned by the user. Also, the reward indication page 500 includes a leaderboard 506 indicating other users associated with the user having the highest amount of connection points. this way, connection points may be used as an incentive for the user to provide relationship information into the system.

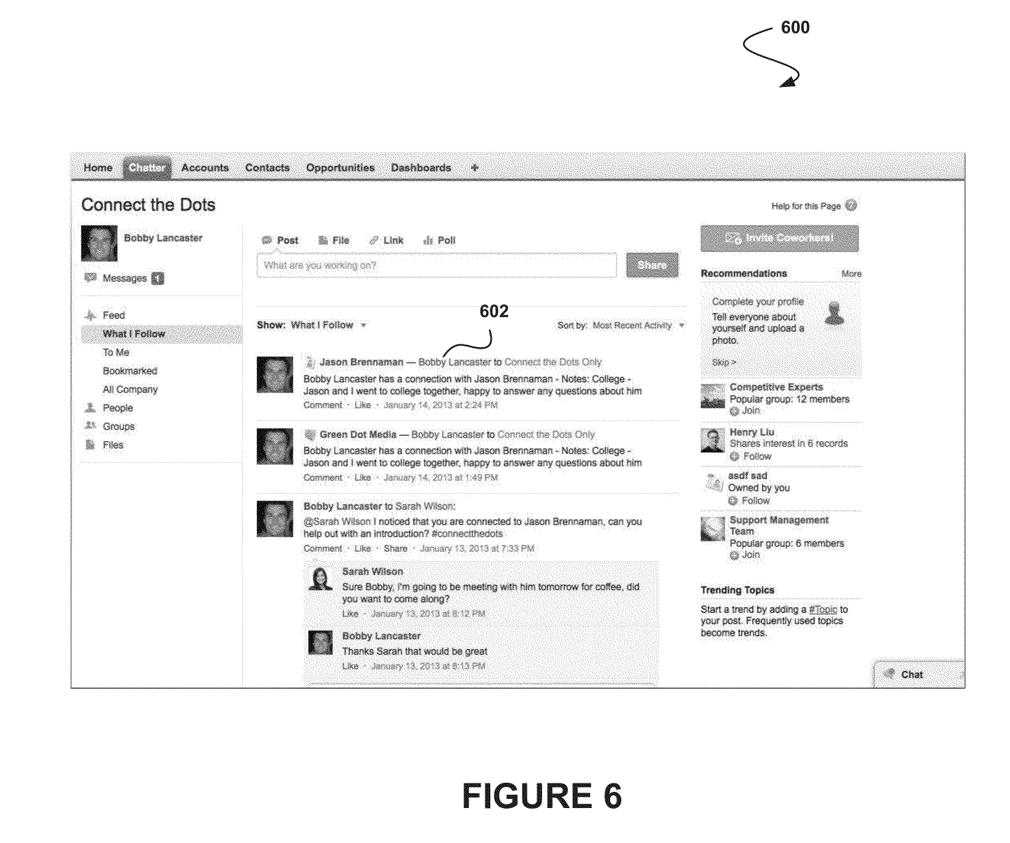

Further still, as shown in operation 214, a notification of the creation of a relationship object is provided. In one embodiment, the notification may include posting an indication of the creation of the relationship on a GUI page associated with the user. In another embodiment, the indication may include details about one or more parameters associated with the object. FIG. 6 illustrates an exemplary user information page 600, in accordance with one embodiment. As shown, the user information page 600 includes an indication 602 that the user has created a relationship with a contact, where the indication 602 includes a plurality of parameters associated with such relationship.

Also, in one embodiment, providing the notification may include posting an indication of the creation of the relationship object on a message service (e.g., an instance message service, etc.). In another embodiment, the notification may be only accessed by users of the system having a predetermined level of access (e.g., access to information associated with the user that provided the relationship information, access to information associated with the contact, etc.).

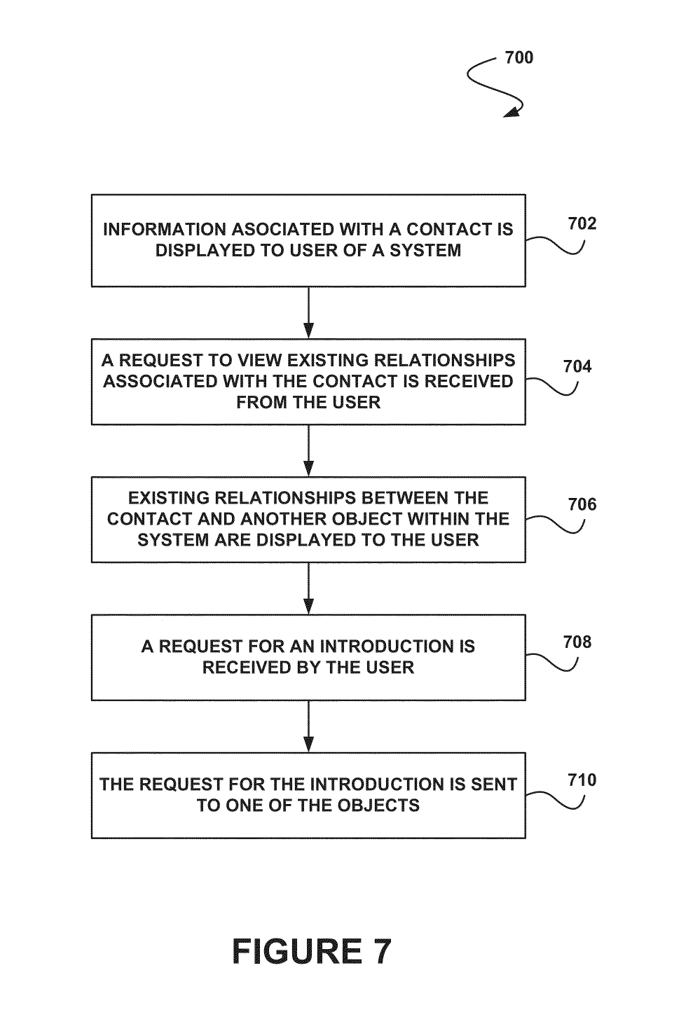

FIG. 7 illustrates a method 700 for interacting with an existing relationship within a system, in accordance with another embodiment. As an option, the present method 700 may be carried out in the context of the functionality of FIGS. 1-6. Of course, however, the method 700 may be carried out in any desired environment. The aforementioned definitions may apply during the present description.

As shown in operation 702, information associated with a contact is displayed to a user of a system. Additionally, as shown in operation 704, a request to view existing relationships associated with the contact is received from the user. In one embodiment, the request may be received in response to the user selecting a link within a GUI. For example, the user may select a link to view relationships associated with the contact from within the contact page. Additionally, the user may select a link to add a relationship with the contact (e.g., a link indicating that the user knows the contact, etc.) from within the contact page.

Further, as shown in operation 706, existing relationships between the contact and another object within the system are displayed to the user. In one embodiment, the existing relationships may be displayed to the user within the contact page. In another embodiment, the existing relationships displayed to the user may be filtered according to one or more access rules. For example, only relationships between the contact and another object associated with the user (e.g., including colleagues or other objects otherwise accessible to the user within the system, etc.) may be viewed by the user.

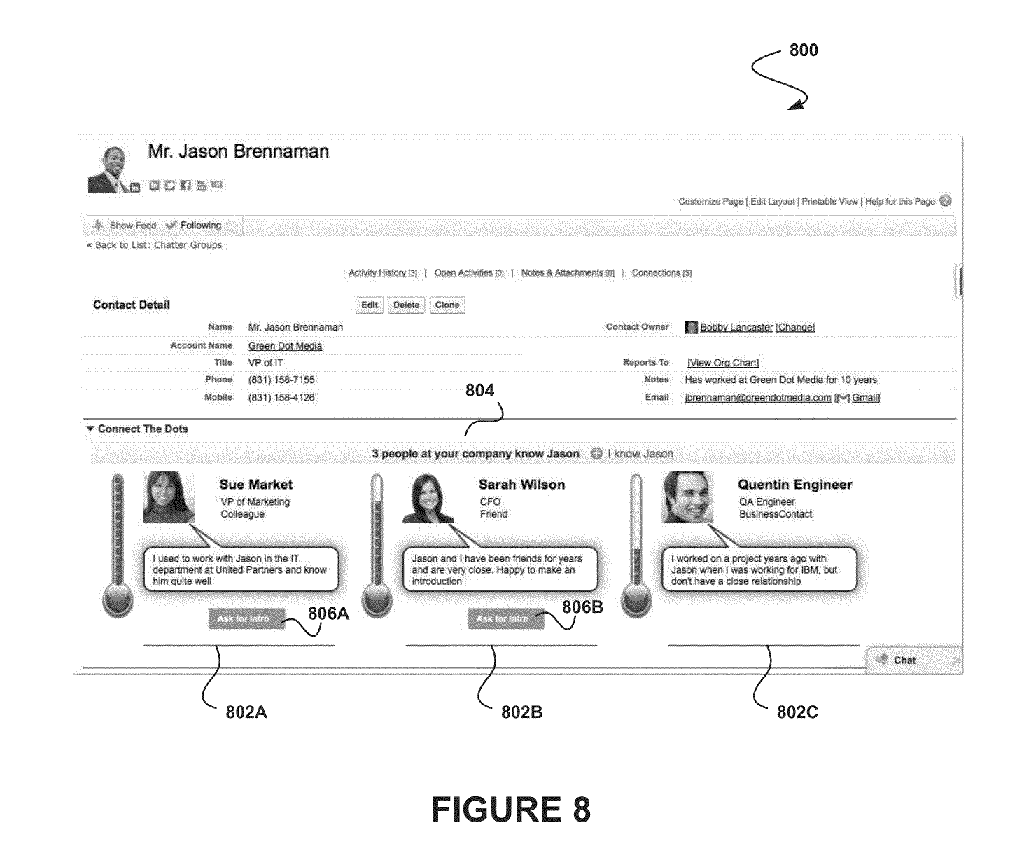

Further still, in one embodiment, information associated with the objects (e.g., job description, business description, etc.) may be provided to the user. In another embodiment, one or more parameters associated with each relationship may be provided to the user. For example, the one or more parameters may include the type of the relationship, the strength of the relationship, a brief summary of the relationship, etc. FIG. 8 illustrates an exemplary contact relationship page 800, in accordance with one embodiment. As shown, the contact information page 800 includes indications 802A-C of relationships with the contact, where each indication 802A-C includes a plurality of parameters associated with such relationship. Also, the contact information page 800 includes an indication 804 of a totally number of additional users associated with the user that have a relationship with the contact.

Also, as shown in operation 708, a request for an introduction is received by the user. In one embodiment, the request may be initiated by the user by selecting a link provided in a GUI. For example, the user may select a link that indicates that another user is willing to introduce the user to the contact. The contact information page 800 of FIG. 8 includes request links 806A-B that enable the user to request that the object associated with the request link 806A-B introduce the requesting user to the contact.

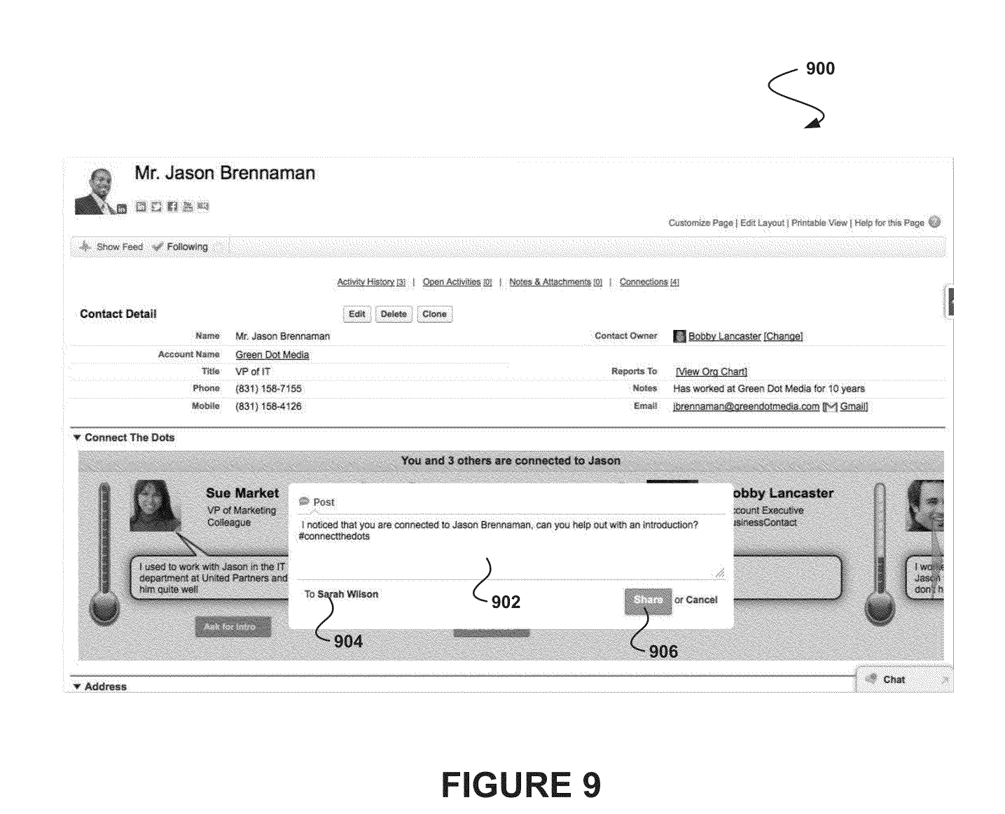

Additionally, in one embodiment, the request for the introduction may be sent by the user, utilizing a form. FIG. 9 illustrates an exemplary introduction request form 900, in accordance with one embodiment. As shown, the request form 900 includes a text box 902 addressed to another object 904 having a relationship to the contact, where the user may enter specific request information regarding the introduction request into the text box 902. In another embodiment, the text box 902 may appear in response to the user selecting one of request links 806A-B. In yet another embodiment, the user may share the request by selecting a share button 906.

Further, as shown in operation 710, the request for the introduction is sent to one of the objects. In one embodiment, the request for the introduction may be sent to the object having a request link selected by the user. In another embodiment, the request may be posted to a web page associated with the object. In yet another embodiment, the request may be sent to the object via an email message, and instant message, a cellular text message, etc. In this way, the object may be notified of the user request to initiate an introduction between the user and the contact.

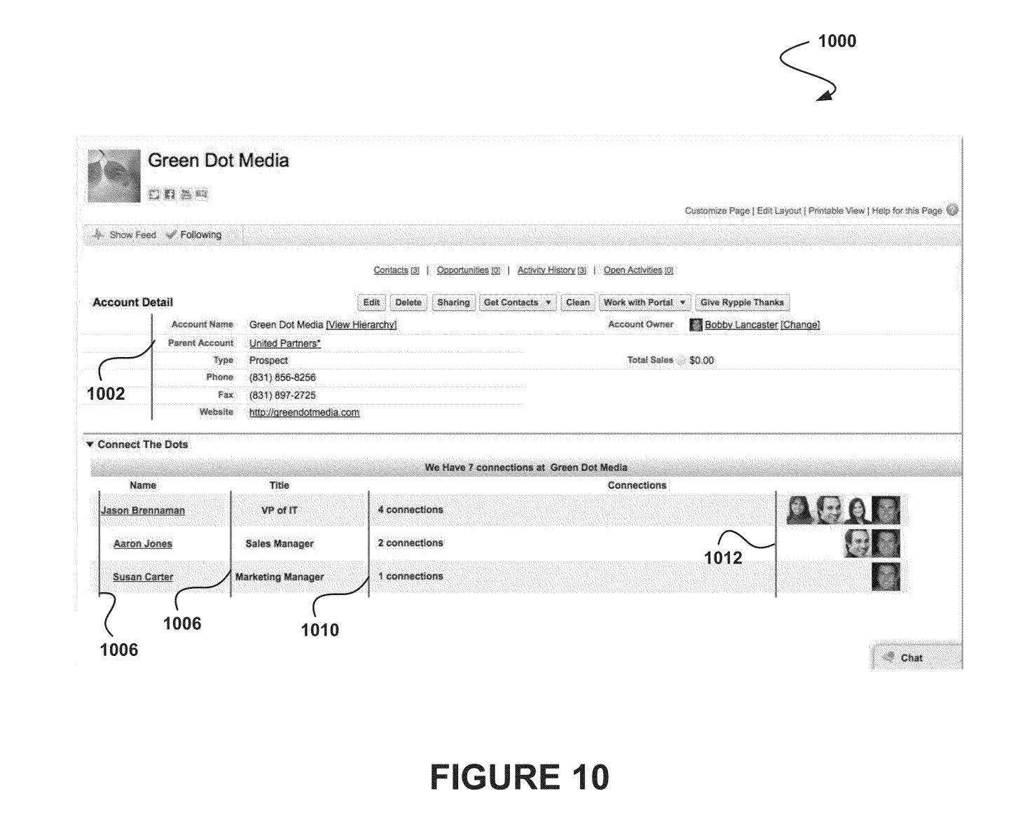

FIG. 10 illustrates an account detail page 1000, in accordance with another embodiment. As an option, the present page 1000 may be carried out in the context of the functionality of FIGS. 1-9. Of course, however, the page 1000 may be carried out in any desired environment. The aforementioned definitions may apply during the present description.

As shown, the account detail page 1000 includes general information 1002 associated with the account, as well as relationship information associated with the account. In one embodiment, the account detail page 1000 may be viewable by a user, and may be representative of an account held by an entity employing the user. The relationship information includes names 1006 of contacts within the account, as well as titles 1008 held by each respective contact. In another embodiment, the account detail page 1000 may be presented in response to a user requesting an account summary (e.g., by selecting an account summary link, etc.).

Additionally, the relationship information also includes a number of connections 1010 between each contact and one or more objects associated with the user. For example, the number of connections 1010 may include a number of connections between each contact and one or more employees of an entity associated with the viewing user. Also, the relationship information includes identifications 1012 of each object having a relationship with each contact. In this way, a user may quickly identify connections between objects associated with the user and contacts held by the user, where these connections may be leveraged by the user for use in business deals, etc.

### System Overview

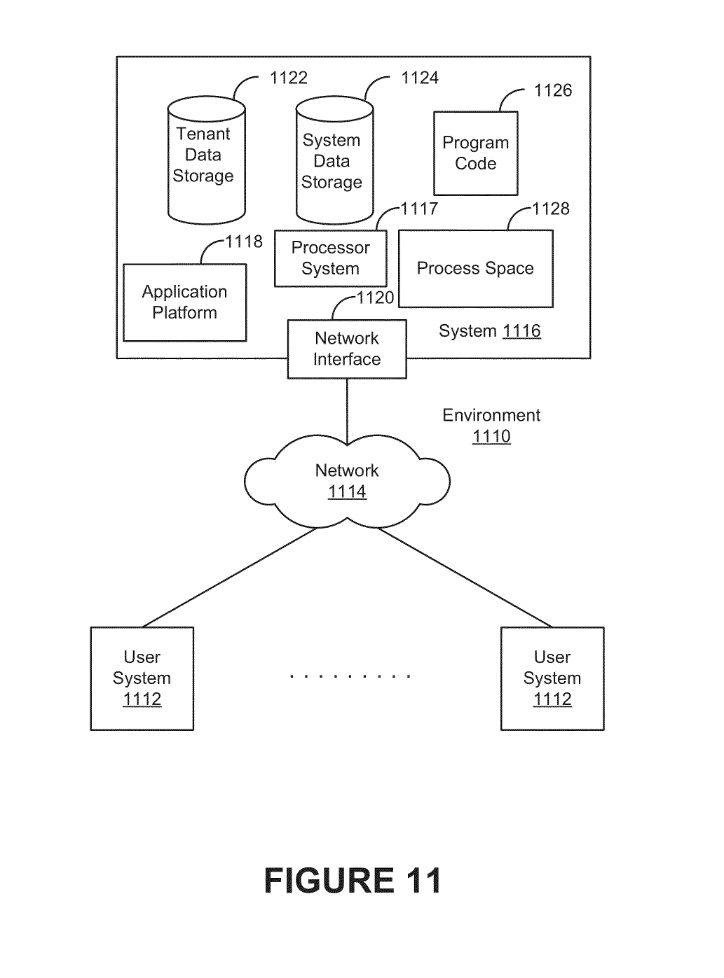

FIG. 11 illustrates a block diagram of an environment 1110 wherein an on-demand database system might be used. Environment 1110 may include user systems 1112, network 1114, system 1116, processor system 1117, application platform 1118, network interface 1120, tenant data storage 1122, system data storage 1124, program code 1126, and process space 1128. In other embodiments, environment 1110 may not have all of the components listed and/or may have other elements instead of, or in addition to, those listed above.

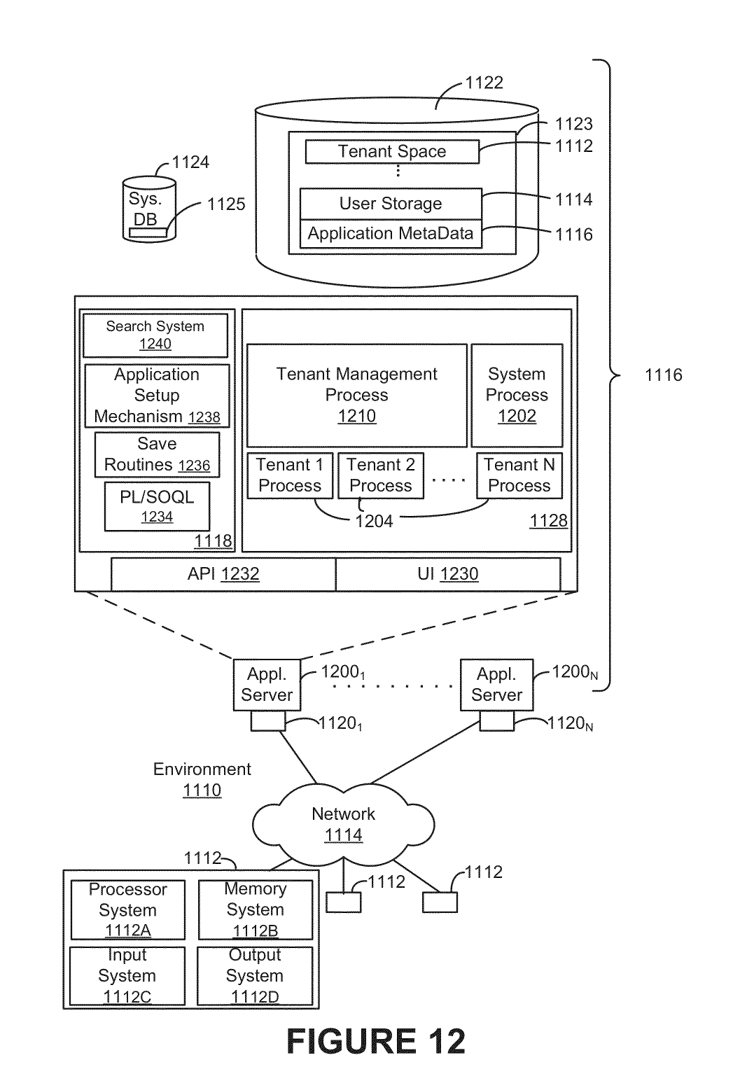

Environment 1110 is an environment in which an on-demand database system exists. User system 1112 may be any machine or system that is used by a user to access a database user system. For example, any of user systems 1112 can be a handheld computing device, a mobile phone, a laptop computer, a work-station, and/or a network of computing devices. As illustrated in FIG. 11 (and in more detail in FIG. 12) user systems 1112 might interact via a network 1114 with an on-demand database system, which is system 1116.

An on-demand database system, such as system 1116, is a database system that is made available to outside users that do not need to necessarily be concerned with building and/or maintaining the database system, but instead may be available for their use when the users need the database system (e.g., on the demand of the users). Some on-demand database systems may store information from one or more tenants stored into tables of a common database image to form a multi-tenant database system (MTS). Accordingly, “on-demand database system 1116” and “system 1116” will be used interchangeably herein. A database image may include one or more database objects. A relational database management system (RDMS) or the equivalent may execute storage and retrieval of information against the database object(s). Application platform 1118 may be a framework that allows the applications of system 1116 to run, such as the hardware and/or software, e.g., the operating system. In an embodiment, on-demand database system 1116 may include an application platform 1118 that enables creation, managing and executing one or more applications developed by the provider of the on-demand database system, users accessing the on-demand database system via user systems 1112, or third party application developers accessing the on-demand database system via user systems 1112.

The users of user systems 1112 may differ in their respective capacities, and the capacity of a particular user system 1112 might be entirely determined by permissions (permission levels) for the current user. For example, where a salesperson is using a particular user system 1112 to interact with system 1116, that user system has the capacities allotted to that salesperson. However, while an administrator is using that user system to interact with system 1116, that user system has the capacities allotted to that administrator. In systems with a hierarchical role model, users at one permission level may have access to applications, data, and database information accessible by a lower permission level user, but may not have access to certain applications, database information, and data accessible by a user at a higher permission level. Thus, different users will have different capabilities with regard to accessing and modifying application and database information, depending on a user's security or permission level.

Network 1114 is any network or combination of networks of devices that communicate with one another. For example, network 1114 can be any one or any combination of a LAN (local area network), WAN (wide area network), telephone network, wireless network, point-to-point network, star network, token ring network, hub network, or other appropriate configuration. As the most common type of computer network in current use is a TCP/IP (Transfer Control Protocol and Internet Protocol) network, such as the global internetwork of networks often referred to as the “Internet” with a capital “I,” that network will be used in many of the examples herein. However, it should be understood that the networks that the one or more implementations might use are not so limited, although TCP/IP is a frequently implemented protocol.

User systems 1112 might communicate with system 1116 using TCP/IP and, at a higher network level, use other common Internet protocols to communicate, such as HTTP, FTP, AFS, WAP, etc. In an example where HTTP is used, user system 1112 might include an HTTP client commonly referred to as a “browser” for sending and receiving HTTP messages to and from an HTTP server at system 1116. Such an HTTP server might be implemented as the sole network interface between system 1116 and network 1114, but other techniques might be used as well or instead. In some implementations, the interface between system 1116 and network 1114 includes load sharing functionality, such as round-robin HTTP request distributors to balance loads and distribute incoming HTTP requests evenly over a plurality of servers. At least as for the users that are accessing that server, each of the plurality of servers has access to the MTS′ data; however, other alternative configurations may be used instead.

In one embodiment, system 1116, shown in FIG. 11, implements a web-based customer relationship management (CRM) system. For example, in one embodiment, system 1116 includes application servers configured to implement and execute CRM software applications as well as provide related data, code, forms, webpages and other information to and from user systems 1112 and to store to, and retrieve from, a database system related data, objects, and Webpage content. With a multi-tenant system, data for multiple tenants may be stored in the same physical database object, however, tenant data typically is arranged so that data of one tenant is kept logically separate from that of other tenants so that one tenant does not have access to another tenant's data, unless such data is expressly shared. In certain embodiments, system 1116 implements applications other than, or in addition to, a CRM application. For example, system 1116 may provide tenant access to multiple hosted (standard and custom) applications, including a CRM application. User (or third party developer) applications, which may or may not include CRM, may be supported by the application platform 1118, which manages creation, storage of the applications into one or more database objects and executing of the applications in a virtual machine in the process space of the system 1116.

One arrangement for elements of system 1116 is shown in FIG. 11, including a network interface 1120, application platform 1118, tenant data storage 1122 for tenant data 1123, system data storage 1124 for system data 1125 accessible to system 1116 and possibly multiple tenants, program code 1126 for implementing various functions of system 1116, and a process space 1128 for executing MTS system processes and tenant-specific processes, such as running applications as part of an application hosting service. Additional processes that may execute on system 1116 include database indexing processes.

Several elements in the system shown in FIG. 11 include conventional, well-known elements that are explained only briefly here. For example, each user system 1112 could include a desktop personal computer, workstation, laptop, PDA, cell phone, or any wireless access protocol (WAP) enabled device or any other computing device capable of interfacing directly or indirectly to the Internet or other network connection. User system 1112 typically runs an HTTP client, e.g., a browsing program, such as Microsoft's Internet Explorer browser, Netscape's Navigator browser, Opera's browser, or a WAP-enabled browser in the case of a cell phone, PDA or other wireless device, or the like, allowing a user (e.g., subscriber of the multi-tenant database system) of user system 1112 to access, process and view information, pages and applications available to it from system 1116 over network 1114. Each user system 1112 also typically includes one or more user interface devices, such as a keyboard, a mouse, trackball, touch pad, touch screen, pen or the like, for interacting with a graphical user interface (GUI) provided by the browser on a display (e.g., a monitor screen, LCD display, etc.) in conjunction with pages, forms, applications and other information provided by system 1116 or other systems or servers. For example, the user interface device can be used to access data and applications hosted by system 1116, and to perform searches on stored data, and otherwise allow a user to interact with various GUI pages that may be presented to a user. As discussed above, embodiments are suitable for use with the Internet, which refers to a specific global internetwork of networks. However, it should be understood that other networks can be used instead of the Internet, such as an intranet, an extranet, a virtual private network (VPN), a non-TCP/IP based network, any LAN or WAN or the like.

According to one embodiment, each user system 1112 and all of its components are operator configurable using applications, such as a browser, including computer code run using a central processing unit such as an Intel Pentium® processor or the like. Similarly, system 1116 (and additional instances of an MTS, where more than one is present) and all of their components might be operator configurable using application(s) including computer code to run using a central processing unit such as processor system 1117, which may include an Intel Pentium® processor or the like, and/or multiple processor units. A computer program product embodiment includes a machine-readable storage medium (media) having instructions stored thereon/in which can be used to program a computer to perform any of the processes of the embodiments described herein. Computer code for operating and configuring system 1116 to intercommunicate and to process webpages, applications and other data and media content as described herein are preferably downloaded and stored on a hard disk, but the entire program code, or portions thereof, may also be stored in any other volatile or non-volatile memory medium or device as is well known, such as a ROM or RAM, or provided on any media capable of storing program code, such as any type of rotating media including floppy disks, optical discs, digital versatile disk (DVD), compact disk (CD), microdrive, and magneto-optical disks, and magnetic or optical cards, nanosystems (including molecular memory ICs), or any type of media or device suitable for storing instructions and/or data. Additionally, the entire program code, or portions thereof, may be transmitted and downloaded from a software source over a transmission medium, e.g., over the Internet, or from another server, as is well known, or transmitted over any other conventional network connection as is well known (e.g., extranet, VPN, LAN, etc.) using any communication medium and protocols (e.g., TCP/IP, HTTP, HTTPS, Ethernet, etc.) as are well known. It will also be appreciated that computer code for implementing embodiments can be implemented in any programming language that can be executed on a client system and/or server or server system such as, for example, C, C++, HTML, any other markup language, Java™, JavaScript, ActiveX, any other scripting language, such as VBScript, and many other programming languages as are well known may be used. (Java™ is a trademark of Sun Microsystems, Inc.).

According to one embodiment, each system 1116 is configured to provide webpages, forms, applications, data and media content to user (client) systems 1112 to support the access by user systems 1112 as tenants of system 1116. As such, system 1116 provides security mechanisms to keep each tenant's data separate unless the data is shared. If more than one MIS is used, they may be located in close proximity to one another (e.g., in a server farm located in a single building or campus), or they may be distributed at locations remote from one another (e.g., one or more servers located in city A and one or more servers located in city B). As used herein, each MTS could include one or more logically and/or physically connected servers distributed locally or across one or more geographic locations. Additionally, the term “server” is meant to include a computer system, including processing hardware and process space(s), and an associated storage system and database application (e.g., OODBMS or RDBMS) as is well known in the art. It should also be understood that “server system” and “server” are often used interchangeably herein. Similarly, the database object described herein can be implemented as single databases, a distributed database, a collection of distributed databases, a database with redundant online or offline backups or other redundancies, etc., and might include a distributed database or storage network and associated processing intelligence.

FIG. 12 also illustrates environment 1110. However, in FIG. 12 elements of system 1116 and various interconnections in an embodiment are further illustrated. FIG. 12 shows that user system 1112 may include processor system 1112A, memory system 1112B, input system 1112C, and output system 1112D. FIG. 12 shows network 1114 and system 1116. FIG. 12 also shows that system 1116 may include tenant data storage 1122, tenant data 1123, system data storage 1124, system data 1125, User Interface (UI) 1230, Application Program interface (API) 1232, PL/SOQL 1234, save routines 1236, application setup mechanism 1238, applications servers 1200₁-1200_{N}, system process space 1202, tenant process spaces 1204, tenant management process space 1210, tenant storage area 1212, user storage 1214, and application metadata 1216. In other embodiments, environment 1110 may not have the same elements as those listed above and/or may have other elements instead of, or in addition to, those listed above.

User system 1112, network 1114, system 1116, tenant data storage 1122, and system data storage 1124 were discussed above in FIG. 11. Regarding user system 1112, processor system 1112A may be any combination of one or more processors. Memory system 1112B may be any combination of one or more memory devices, short term, and/or long term memory. Input system 1112C may be any combination of input devices, such as one or more keyboards, mice, trackballs, scanners, cameras, and/or interfaces to networks. Output system 1112D may be any combination of output devices, such as one or more monitors, printers, and/or interfaces to networks. As shown by FIG. 12, system 1116 may include a network interface 1120 (of FIG. 11) implemented as a set of HTTP application servers 1200, an application platform 1118, tenant data storage 1122, and system data storage 1124. Also shown is system process space 1202, including individual tenant process spaces 1204 and a tenant management process space 1210. Each application server 1200 may be configured to tenant data storage 1122 and the tenant data 1123 therein, and system data storage 1124 and the system data 1125 therein to serve requests of user systems 1112. The tenant data 1123 might be divided into individual tenant storage areas 1212, which can be either a physical arrangement and/or a logical arrangement of data. Within each tenant storage area 1212, user storage 1214 and application metadata 1216 might be similarly allocated for each user. For example, a copy of a user's most recently used (MRU) items might be stored to user storage 1214. Similarly, a copy of MRU items for an entire organization that is a tenant might be stored. to tenant storage area 1212. A UI 1230 provides a user interface and an API 1232 provides an application programmer interface to system 1116 resident processes to users and/or developers at user systems 1112. The tenant data and the system data may be stored in various databases, such as one or more Oracle™ databases,

Application platform 1118 includes an application setup mechanism 1238 that supports application developers' creation and management of applications, which may be saved as metadata into tenant data storage 1122 by save routines 1236 for execution by subscribers as one or more tenant process spaces 1204 managed by tenant management process 1210 for example. Invocations to such applications may he coded using PL/SOQL 1234 that provides a programming language style interface extension to API 1232. A detailed description of some PL/SOQL language embodiments is discussed in commonly owned co-pending U.S. Provisional Patent Application 60/828,192 entitled, PROGRAMMING LANGUAGE METHOD AND SYSTEM FOR EXTENDING APIS TO EXECUTE IN CONJUNCTION WITH DATABASE APIS, by Craig Weissman, filed Oct. 4, 2006, which is incorporated in its entirety herein for all purposes. Invocations to applications may be detected by one or more system processes, which manages retrieving application metadata 1216 for the subscriber making the invocation and executing the metadata as an application in a virtual machine.

Each application server 1200 may be communicably coupled to database systems, e.g., having access to system data 1125 and tenant data 1123, via a different network connection. For example, one application server 1200₁ might be coupled via the network 1114 (e.g., the Internet.), another application server 1200_{N-1} might be coupled via a direct network link, and another application server 1200_{N} might be coupled by yet a different network connection. Transfer Control Protocol and Internet Protocol (TCP/IP) are typical protocols for communicating between application servers 1200 and the database system. However, it will be apparent to one skilled in the art that other transport protocols may be used to optimize the system depending on the network interconnect used.

In certain embodiments, each application server 1200 is configured to handle requests for any user associated with any organization that is a tenant. Because it is desirable to be able to add and remove application servers from the server pool at any time for any reason, there is preferably no server affinity for a user and/or organization to a specific application server 1200. In one embodiment, therefore, an interface system implementing a load balancing function (e.g., an F5 Big-IP load balancer) is communicably coupled between the application servers 1200 and the user systems 1112 to distribute requests to the application servers 1200. In one embodiment, the load balancer uses a least connections algorithm to route user requests to the application servers 1200. Other examples of load balancing algorithms, such as round robin and observed response time, also can be used. For example, in certain embodiments, three consecutive requests from the same user could hit three different application servers 1200, and three requests from different users could hit the same application server 1200. In this manner, system 1116 is multi-tenant, wherein system 1116 handles storage of, and access to, different objects, data and applications across disparate users and organizations.

As an example of storage, one tenant might be a company that employs a sales force where each salesperson uses system 1116 to manage their sales process. Thus, a user might maintain contact data, leads data, customer follow--up data, performance data, goals and progress data, etc., all applicable to that user's personal sales process (e.g., in tenant data storage 1122). in an example of a MTS arrangement, since all of the data and the applications to access, view, modify, report, transmit, calculate, etc., can be maintained and accessed by a user system having nothing more than network access, the user can manage his or her sales efforts and cycles from any of many different user systems. For example, if a salesperson is visiting a customer and the customer has Internet access in their lobby, the salesperson can obtain critical updates as to that customer while waiting for the customer to arrive in the lobby.

While each user's data might be separate from other users' data regardless of the employers of each user, some data might be organization-wide data shared or accessible by a plurality of users or all of the users for a given organization that is a tenant. Thus, there might be some data structures managed by system 1116 that are allocated at the tenant level while other data structures might be managed at the user level. Because an MTS might support multiple tenants including possible competitors, the MTS should have security protocols that keep data, applications, and application use separate. Also, because many tenants may opt for access to an MTS rather than maintain their own system, redundancy, up-time, and backup are additional functions that may be implemented in the MTS. In addition to user-specific data and tenant specific data, system 1116 might also maintain system level data usable by multiple tenants or other data. Such system level data might include industry reports, news, postings, and the like that are sharable among tenants.

In certain embodiments, user systems 1112 (which may be client systems) communicate with application servers 1200 to request and update system-level and tenant-level data from system 1116 that may require sending one or more queries to tenant data storage 1122 and/or system data storage 1124. System 1116 (e.g., an application server 1200 in system 1116) automatically generates one or more SQL statements (e.g., one or more SQL queries) that are designed to access the desired information. System data storage 1124 may generate query plans to access the requested data from the database.

Each database can generally be viewed as a collection of objects, such as a set of logical. tables, containing data fitted into predefined categories. A “table” is one representation of a data object, and may be used herein to simplify the conceptual description of objects and custom objects. It should be understood that “table” and “object” may be used interchangeably herein. Each table generally contains one or more data categories logically arranged as columns or fields in a viewable schema. Each row or record of a table contains an instance of data for each category defined by the fields. For example, a CRM database may include a table that describes a customer with fields for basic contact information such as name, address, phone number, fax number, etc. Another table might describe a purchase order, including fields for information such as customer, product, sale price, date, etc. In some multi-tenant database systems, standard entity tables might be provided for use by all tenants. For CRM database applications, such standard entities might include tables for Account, Contact, Lead, and Opportunity data, each containing pre-defined fields. It should be understood that the word “entity” may also be used interchangeably herein with “object” and “table”.

In some multi-tenant database systems, tenants may be allowed to create and store custom objects, or they may be allowed to customize standard entities or objects, for example by creating custom fields for standard objects, including custom index fields, U.S. patent application Ser. No. 10/817,161, filed Apr. 2, 2004, entitled “Custom Entities and Fields in a Multi-Tenant Database System”, and which is hereby incorporated herein by reference, teaches systems and methods for creating custom objects as well as customizing standard objects in a multi-tenant database system. in certain embodiments, for example, all custom entity data rows are stored in a single multi-tenant physical table, which may contain multiple logical tables per organization. It is transparent to customers that their multiple “tables” are in fact stored in one large table or that their data may be stored in the same table as the data of other customers.

While one or more implementations have been described by way of example and in terms of the specific embodiments, it is to be understood that one or more implementations are not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

1. A computer program product embodied on a tangible computer readable medium, comprising:
computer code for identifying a first object and a second object within a system;
computer code for defining a relationship between the first object and the second object; and
computer code for storing the defined relationship within the system.

2. The computer program product of claim 1, wherein the system includes a customer relationship management (CRM) system

3. The computer program product of claim 1, wherein one or more of the first and second objects include an object representative of a user of the system.

4. The computer program product of claim 1, wherein one or more of the first and second objects include a contact within the system.

5. The computer program product of claim 1, wherein one or more of the first and second objects include an account within the system.

6. The computer program product of claim 1, wherein the first object and the second object are imported from an external system into the system.

7. The computer program product of claim 1, wherein the relationship includes one or more parameters.

8. The computer program product of claim 7, wherein the parameters include one or more of a type of the relationship, the strength of the relationship, and a textual description of the relationship.

9. The computer program product of claim 1, wherein the relationship includes one or more of an ability and willingness of one or more entities associated with the relationship to make an introduction.

10. The computer program product of claim 1, wherein the first object includes a user, the second object includes a contact, and the relationship between the first and second object includes a willingness of the user to initiate an introduction between the contact and a third party.

11. The computer program product of claim 1, wherein the relationship is stored as an object within the system.

12. The computer program product of claim 1, further comprising assigning a user one or more credits if the relationship between the first object and the second object is defined by the user.

13. The computer program product of claim 12, wherein an amount of credits assigned to the user varies based on one or more parameters of the relationship.

14. The computer program product of claim 1, further comprising posting one or more messages in response to the defining and storing of the relationship.

15. The computer program product of claim 14, wherein one or more messages are posted to a web page associated with one or more of the first and second object in response to the defining and storing of the relationship.

16. The computer program product of claim 1, wherein the stored relationship is displayed when viewing details of the first object or the second object.

17. The computer program product of claim 16, wherein an option to request an introduction is conditionally provided in association with the display of the stored relationship.

18. The computer program product of claim 4, further comprising performing an analysis, utilizing the stored relationship.

19. A method, comprising:
identifying a first object and a second object within a system;
defining a relationship between the first object and the second object; and
storing the defined relationship within the system.

20. An apparatus, comprising:
a processor for:
identifying a first object and a second object within a system;
defining a relationship between the first object and the second object; and
storing the defined relationship within the system.

21. A method for transmitting code for use in a multi-tenant database system on a transmission medium, the method comprising:
transmitting code for identifying a first object and a second object within a system;
transmitting code for defining a relationship between the first object and the second object; and
transmitting code for storing the defined relationship within the system.
